(19) United States
(12) Patent Application Publication
(10) Pub. No.: US 2001/0033102 A1
(43) Pub. Date: Oct. 25, 2001

(54) Shoulder strap repositioner for vehicle seat belt assembly

(76) Inventor: Brian J. Conaway, Columbus, OH (US)

Correspondence Address: Steven C. Schnedler, Carter & Schnedler, P.A., P.O. Box 2985, Asheville, NC, 28802, US

(21) Appl. No.: 09/780,942

(22) Filed: Feb. 9, 2001

Related U.S. Application Data
(60) Provisional application No. 60/181,730, filed on Feb. 11, 2000.

(51) Int. Cl. B60R 22/10

(52) U.S. Cl. 297/483

(57) ABSTRACT

A shoulder strap repositioner or “adjuster” for use in combination with a vehicle seat belt assembly having a lap belt and a diagonally-extending shoulder strap. Attached to a body central portion are left and right side wings each having a downwardly extending upper finger and an upwardly extending lower finger, with a gap between their distal ends. The fingers, in cooperation with the central portion, together define slots accessed via the gaps.

### CROSS-REFERENCE TO PROVISIONAL PATENT APPLICATION

The benefit of U.S. Provisional Patent Application Ser. No. 60/181,730, filed Feb. 11, 2000, is claimed.

### BACKGROUND OF THE INVENTION

The invention relates generally to vehicle seat belt assemblies of the type having a lap belt and a diagonally-extending shoulder strap. The invention more particularly relates to shoulder strap repositioners, which may also be referred to as “adjusters,” for repositioning or deflecting the diagonally-extending shoulder strap component of vehicle seat belt assemblies.

Conventional seat belt assemblies, which include a lap belt and a diagonally-extending shoulder strap, are designed primarily for use by adults of average size. When used by an adult, the shoulder strap extends generally across the chest and shoulder of the individual.

However, when the seat belt assembly is used by a child or smaller adult, the shoulder strap typically extends across the neck or face of the child because his or her upper body is not quite as long as that of a taller individual.

A variety of shoulder strap repositioners or “adjusters,” particularly for use by children, have been proposed, and several have been commercially produced. Particularly relevant in the context of the subject invention are the devices disclosed in Shreier et al U.S. Pat. No. 4,786,078; Blake U.S. Pat. No. 5,154,446 and Campbell U.S. Pat. No. 5,201,099.

### SUMMARY OF THE INVENTION

In an exemplary embodiment, a shoulder strap repositioner takes the form of a body positionable against the torso of a seated person. The body includes a central portion having a rear surface that faces the torso during use, and an opposed front surface. The body additionally includes left and right side wings each having a rear surface that faces the torso during use, and an opposed front surface. Each of the side wings includes upper and lower base portions attached to the central portion. An upper finger extends from an upper finger proximal end attached to the upper base portion downwardly to an upper finger distal end, a lower finger extending from a lower finger proximal end attached to the lower base portion upwardly to a lower finger distal end. A gap is defined between the upper and lower finger distal ends. The upper and lower fingers, in cooperation with the central portion, together define generally vertically extending left and right side slots accessed via the gaps. The slots and gaps are configured such that, for use, the lap belt and shoulder strap are inserted through the gaps, and such that, during use, the shoulder strap passes through the slots and the lap belt at least engages the lower fingers, with the lap belt and shoulder strap crossing over portions of the front surfaces of the side wings and crossing over portions of the rear surface of the central portion.

In another exemplary embodiment a shoulder strap repositioner comprises a body positionable against the torso of a seated person. The body also includes a central portion and left and right side wings. Each of the side wings includes upper and lower base portions attached to the central portion. An upper relatively inner finger extends from an upper relatively inner finger proximal end attached to the upper base portion downwardly to an upper relatively inner finger distal end, and a lower relatively inner finger extends from a lower relatively inner finger proximal end attached to the lower base portion upwardly to a lower relatively inner finger distal end. A relatively inner gap is defined between the upper and lower relatively inner finger distal ends. The upper and lower relatively inner fingers, in cooperation with the central portion, together define generally vertically extending relatively inner left and right side slots accessed via the relatively inner gaps. In addition, an upper relatively outer finger extends from an upper relatively outer finger proximal end attached to the upper base portion downwardly to an upper relatively outer finger distal end, and a lower relatively outer finger extends from a lower relatively outer finger proximal end attached to the lower base portion upwardly to a lower relatively outer finger distal end. A relatively outer gap is defined between the upper and lower relatively outer finger distal ends. The upper and lower relatively outer fingers, in cooperation with the upper and lower relatively inner fingers, together define generally vertically extending relatively outer left and right side slots accessed via the relatively outer gaps. The slots and gaps are configured such that, for use, the shoulder strap is inserted through the relatively inner gaps and the lap belt is inserted through the relatively outer gaps and such that, during use, the shoulder belt passes through the relatively inner slots and the lap belt at least engages the lower relatively outer fingers, with the lap belt and shoulder strap crossing over portions of the front surfaces of the side wings and crossing over portions of the rear surface of the central portion.

### BRIEF DESCRIPTION OF THE DRAWINGS

FIG. 1 depicts a shoulder strap repositioner embodying the invention in use;

FIG. 2 is an enlarged front elevational view of the respositioner of FIG. 1;

FIG. 3 is a side elevational view taken on line 3-3 of FIG. 2;

FIG. 4 is a cross-section taken on line 4-4 of FIG. 2;

FIG. 5 is a cross-section taken on line 5-5 of FIG. 2;

FIG. 6 schematically depicts the manner in which the repositioner is attached to the shoulder strap;

FIG. 7 schematically depicts the manner in which the repositioner is subsequently attached to the lap belt;

FIG. 8 is an enlarged view depicting the repositioner in use;

FIG. 9 is a front elevational view of another shoulder strap repositioner embodying the invention;

FIG. 10 is a front elevational view of yet another shoulder strap repositioner embodying the invention;

FIG. 11 is a side elevational view taken on line 11-11 of FIG. 10; and

FIG. 12 is a rear elevational view thereof.

### DETAILED DESCRIPTION

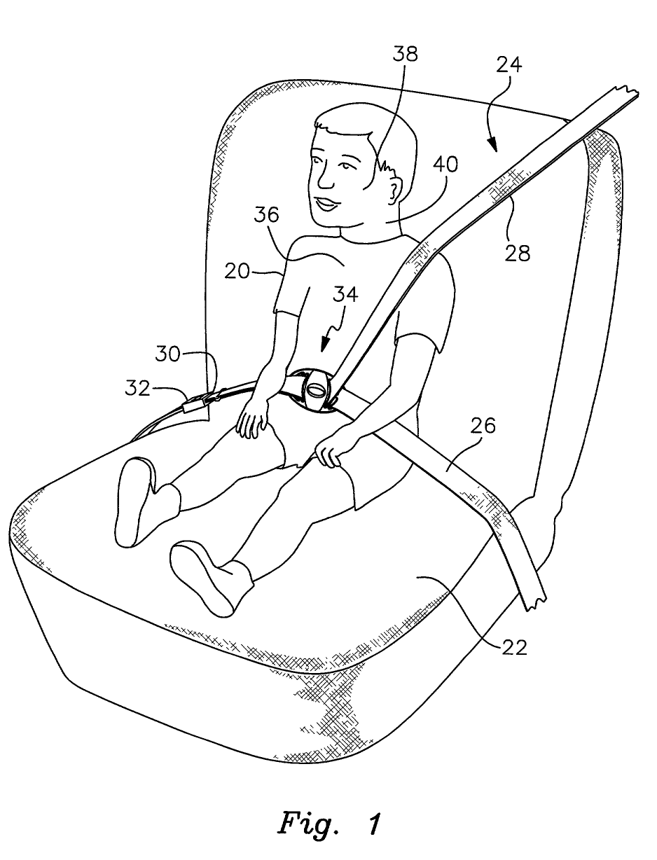

Referring first to FIG. 1, a child 20 or an adult of short stature is seated in a vehicle seat 22 equipped with a conventional seat belt assembly, generally designated 24. The seat belt assembly 24 includes a lap belt 26 and a diagonally-extending shoulder strap 28 attached to one element 30 of a buckle device 32. A shoulder strap repositioner 34 embodying the invention is positioned against the torso of the child 20, or other seated person. In the absence of deflection provided by the repositioner 34, the shoulder strap 28 undesirably would tend to cross the face 38 or neck 40 of the child 20.

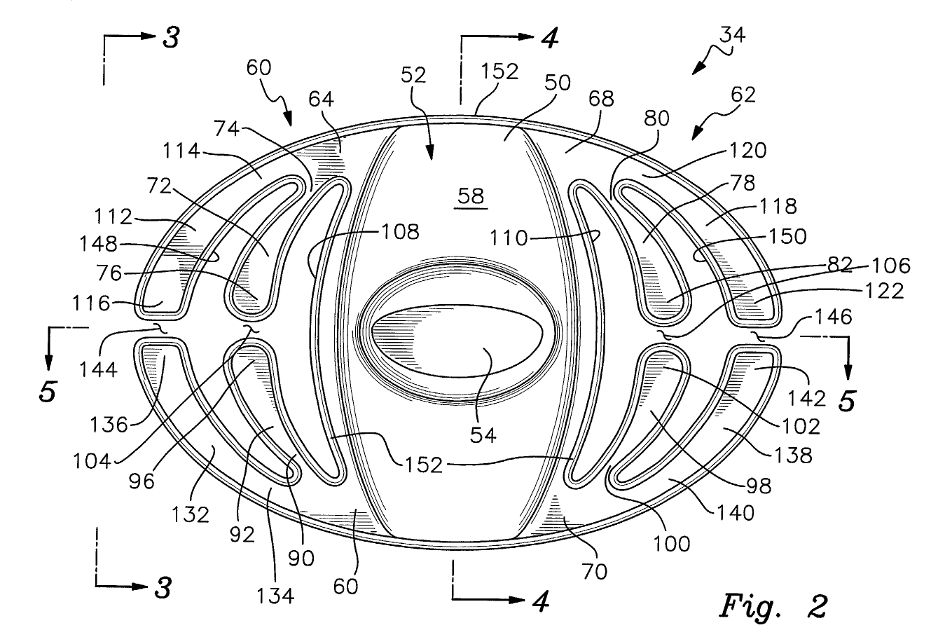

Referring now additionally to FIGS. 2-5, the repositioner 34 comprises a body 50, molded in one piece of a plastic such as LLDPE, or some other material which has a suitable combination of stiffness and flexibility to function as described hereinbelow. The repositioner 34 is symmetrical about a vertical center line, so that it can be used with right-hand or left-hand vehicle seat belt assemblies 24.

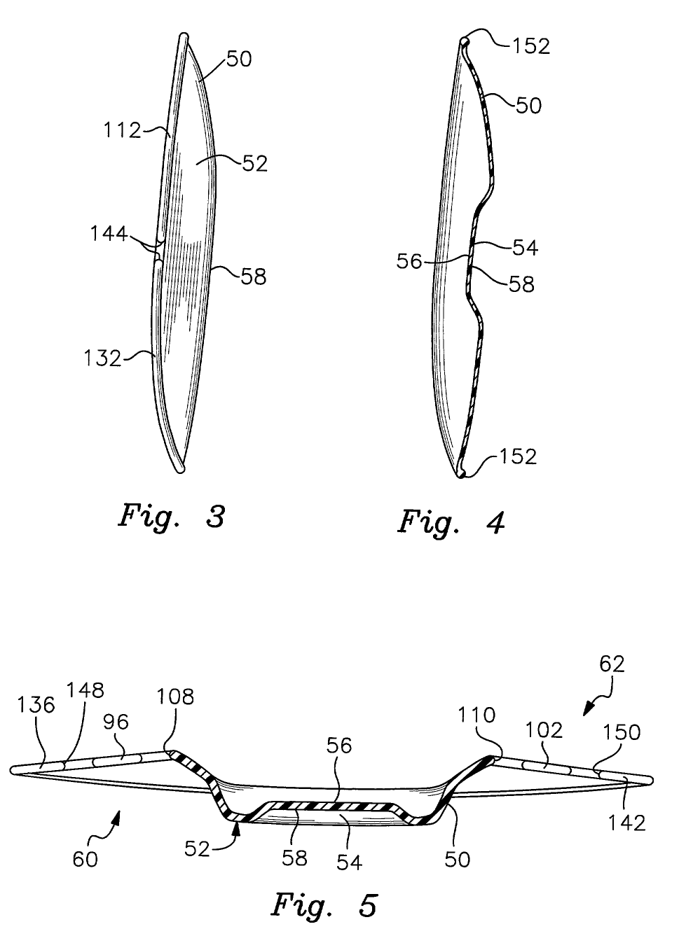

The repositioner body 50 has a central portion 52 which is generally convex when viewed from the front as in FIG. 2, with a central ornamental feature 54. The ornamental feature 54 takes the form of a concave recess when viewed from the front. When viewed from the rear, and as may be seen in the cross-sectional views of FIGS. 4 and 5, the central portion 52 in general is concave, while the ornamental feature 54 is convex. The central portion 52 has a rear surface 56 that faces the torso 36 during use, and an opposed front surface 58. As may be seen in the side elevational view of FIG. 3 and in the cross-section of FIG. 4, the body 50 of the repositioner 34 is curved to accommodate the pelvic contour of the user.

Integrally attached to the central portion 52 are a left side wing 60 and a right side wing 62. The left side wing 60 in turn includes an upper base portion 64 and a lower base portion 66. Correspondingly, the right side wing 62 in turn includes an upper base portion 68 and a lower base portion 70.

On the left side, an upper relatively inner finger 72 extends from an upper relatively inner finger 72 proximal end 74 attached to the upper base portion 64 downwardly to an upper relatively inner finger 72 distal end 76. Correspondingly, on the right side, an upper relatively inner finger 78 extends from an upper relatively inner finger 78 proximal end 80 attached to the upper base portion 68 downwardly to an upper relatively inner finger 78 distal end 82.

Again on the left side, a lower relatively inner finger 92 extends from a lower relatively inner finger 92 proximal end 94 attached to the lower base portion 66 of the left side wing 60 upwardly to a lower relatively inner finger 92 distal end 96. The left side upper and lower relatively inner fingers 72 and 92 thus define a left side inner finger pair. Correspondingly, on the right side, a lower relatively inner finger 98 extends from a lower relatively inner finger 98 proximal end 100 attached to the lower base portion 70 of the right side wing 62 upwardly to a lower relatively inner finger 98 distal end 102. The right side upper and lower relatively inner fingers 78 and 98 thus define a right side inner finger pair.

A left side relatively inner gap 104 is defined between the distal ends 76 and 96 of the left side inner finger pair 72, 92. A right side relatively inner gap 106 is defined between the distal ends 82 and 102 of the right side inner finger pair 78, 98.

The left side upper relatively inner finger 72 and the left side lower relatively inner finger 92, in cooperation with the central portion 52, together define a generally vertically extending relatively inner left side slot 108, accessed via the left side relatively inner gap 104. Correspondingly, the right side upper relatively inner finger 78 and the right side lower relatively inner finger 98, in cooperation with the central portion 52, together define a generally vertically extending relatively inner right side slot 110, accessed via the right side relatively inner gap 106.

In addition to the relatively inner left and right side finger pairs 72, 92 and 78, 98, there are pairs of relatively outer flexible fingers.

Thus, on the left side an upper relatively outer finger 112 extends from an upper relatively outer finger 112 proximal end 114 attached to the upper base portion 64 of the left side wing 60 downwardly to an upper relatively outer finger 112 distal end 116. Correspondingly, on the right side an upper relatively outer finger 118 extends from an upper relatively outer finger 118 proximal end 120 attached to the upper base portion 68 of the right side wing 62 downwardly to an upper relatively outer finger 118 distal end 122.

Again on the left side, a lower relatively outer finger 132 extends from a lower relatively outer finger 132 proximal end 134 attached to the lower base portion 66 of the left side wing 60 upwardly to a lower relatively outer finger 132 distal end 136. The left side upper and lower relatively outer fingers 112 and 132 thus define a left side outer finger pair. Correspondingly, on the right side, a lower relatively inner finger 138 extends from a lower relatively inner finger 138 proximal end 140 attached to the lower base portion 70 of the right side wing 62 upwardly to a lower relatively inner finger 138 distal end 142. The right side upper and lower relatively outer fingers 118 and 138 thus define a right side outer finger pair.

A left side relatively outer gap 144 is defined between the distal ends 116 and 136 of the left side outer finger pair 112, 132. Similarly, a right side outer gap 146 is defined between the distal ends 122 and 142 of the right side upper and lower outer finger pair 118, 138.

On the left side, the upper and lower relatively outer fingers 112 and 132, in cooperation with the upper and lower relatively inner fingers 72 and 92 together define a generally vertically extending relatively outer left side slot 148 accessed via the relatively outer gap 144. Correspondingly, the right side upper and lower relatively outer fingers 118 and 138, in cooperation with the upper and lower relatively inner fingers 78 and 98, define a generally vertically extending relatively outer right side slot 150, accessed via the right side relatively outer gap 146.

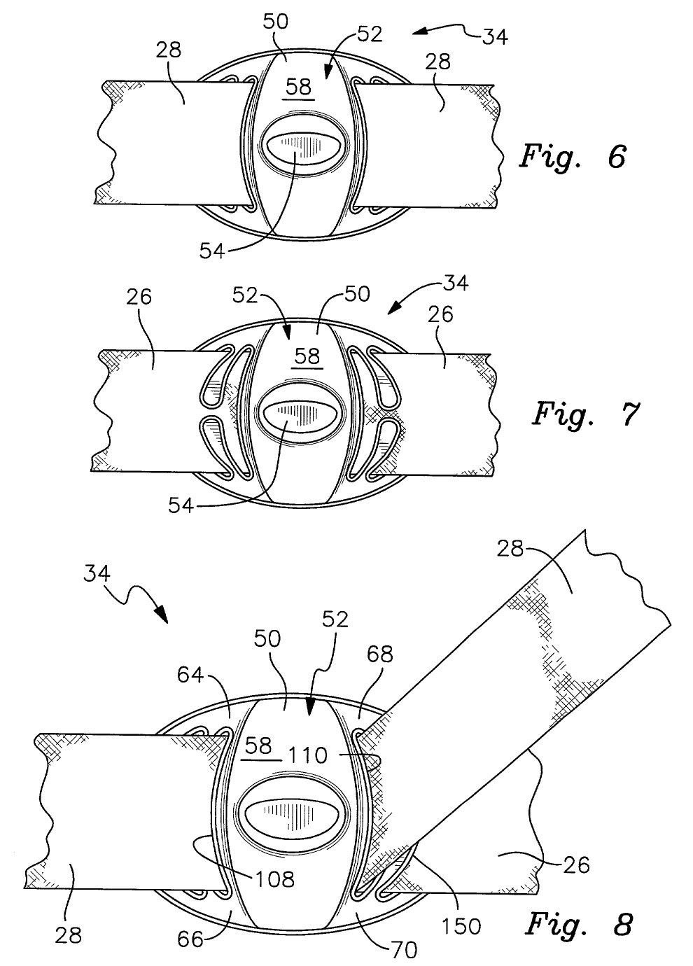

With reference to FIGS. 6, 7 and 8, for installation and use, the user sits in the vehicle seat 22, with the lap belt 26 and shoulder strap 28 in the correct position. With particular reference to FIG. 6, the fingers 72, 78, 92, 98, 112, 118, 132 and 138 are flexed as needed to position the shoulder strap 28 between the relatively inner finger pairs 72, 92 and 78, 98 and the central portion 52, passing through the relatively inner left and right side slots 108 and 110. Insertion of the shoulder strap 28 is made possible on the left side by the gaps 104 and 144 and, on the right side, by the gaps 106 and 146.

Then, and with particular reference to FIG. 7, the relatively outer finger pairs 112, 132 and 118, 138 are flexed as needed, and the lap belt 26 is positioned between the outer finger pairs 112, 132 and the inner finger pairs 72, 92 and 78, 98, passing through the relatively outer left and right side slots 148 and 150. (In FIG. 7, for purposes of illustration, the shoulder strap 28 is not shown.) Insertion of the lap belt 26 is made possible by the relatively outer left and right side gaps 144 and 146.

However, it is not necessary for the lap belt 26 to fully engage the relatively outer left and right side slots 148 and 150. Thus, it is sufficient for the lap belt 26, or at least the lower edge thereof, to engage only the lower relatively outer fingers 132 and 138. Engagement with the upper relatively outer fingers 112 and 118 is not required. In any event, in the final installed configuration, the lap belt 26 and shoulder strap 28 cross over portions of the front surfaces of the side wings 60 and 62, and cross over portions of the rear surface 56 of the central portion 52.

The repositioner 34 is then slid to the left or right, as required, to allow the shoulder strap 28 to ride in the most comfortable position midway between the neck 40 and shoulder, as illustrated in FIG. 1. The grip provided by the finger pairs 72, 92; 78, 98; 112, 132 and 118, 138 and the central portion 52 allows the repositioner 34 to be held in place, while still allowing the user to move the repositioner 34 left or right along the lap belt 26 to provide a comfortable fit of the diagonally-extending shoulder strap 28 for the user. The grip is aided by a bead 152 along the edges of the slots 108, 110, 148 and 150. The bead 152 actually extends continuously along all exposed edges of the body 50, thus avoiding sharp edges.

The material has the correct combination of stiffness and flexibility to allow the finger pairs 72, 92; 78, 98; 112, 132 and 118, 138 to hold the repositioner 34 in place. In addition, the relatively outer finger pairs 112, 132 and 118, 138 flex in the event of an accident in order to allow the shoulder strap 28 to separate from the lap belt 26 and move to an optimum position of the diagonal shoulder strap 28 in order to protect the user in a manner consistent with the designed function of the vehicle seat belt assembly 24. In the alternative attachment connection, wherein the lap belt 26 is engaged only by the lower relatively outer fingers 132 and 138, the same result is achieved. In either event, the repositioner 34 remains attached to the diagonally-extending shoulder strap 28, and so does not become a projectile in the event of an accident.

Further, to prevent distortion during use, the central portion.52 is relatively rigid compared to the fingers 72, 78, 92, 98, 112, 118, 132 and 138. The profile of the central portion 52, as is perhaps best seen in the cross-sectional view of FIG. 5, aids in maintaining rigidity.

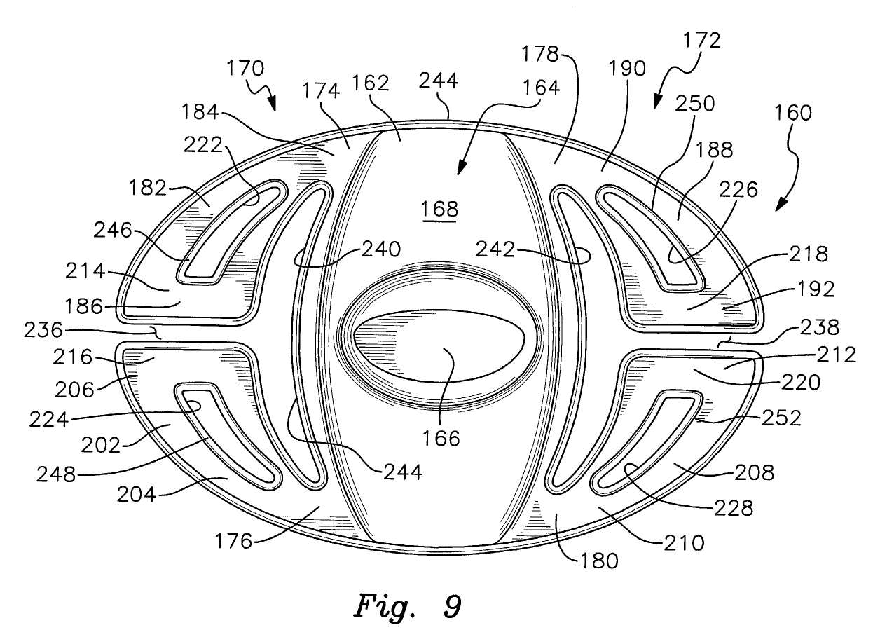

With reference now to FIG. 9, depicted is another repositioner 160 embodiment, differing from the repositioner 34 of FIGS. 1-8 in that on each side there is only a single finger pair, and a single slot. In other respects, the FIG. 9 repositioner 160 is similar to the repositioner 34 of FIGS. 1-8, and the side elevational view of FIG. 3, as well as the cross-sectional views of FIGS. 4 and 5 are applicable.

Like the repositioner 34, the repositioner 160 of FIG. 9 comprises a body 162, also molded in one piece of a plastic such as LLDPE, or some other material which has a suitable combination of stiffness and flexibility to function as described herein. The repositioner 160 is symmetrical about a vertical center line, so that it can be used with right-hand or left-hand vehicle seat belt assemblies 24.

The repositioner body 162 has a central portion 164 which is generally convex when viewed from the front as in FIG. 9, with a central ornamental feature 166. The ornamental feature 166 takes the form of a concave recess when viewed from the front. The central portion 164 has a rear surface that faces the torso 36 during use (like the rear surface 56), and an opposed front surface 168. The body 162 of the repositioner 160 is curved to accommodate the pelvic contour of the user.

Integrally attached to the central portion 164 are a left side wing 170 and a right side wing 172. The left side wing 170 in turn includes an upper base portion 174 and a lower base portion 176. Correspondingly, the right side wing 172 in turn includes an upper base portion 178 and a lower base portion 180.

On the left side, a single upper finger 182 extends from an upper finger 182 proximal end 184 attached to the upper base portion 174 downwardly to an upper finger 182 distal end 186. Correspondingly, on the right side, a single upper finger 188 extends from an upper finger 188 proximal end 190 attached to the upper base portion 178 downwardly to an upper finger 188 distal end 192.

Again on the left side, a single lower finger 202 extends from a lower finger 202 proximal end 204 attached to the lower base portion 176 of the left side wing 170 upwardly to a lower finger 202 distal end 206. The left side upper and lower fingers 182 and 202 thus define a left side pair. Correspondingly, on the right side, a single lower finger 208 extends from a lower relatively inner finger 208 proximal end 210 attached to the lower base portion 180 of the right side wing 172 upwardly to a lower finger 208 distal end 212. The right side upper and lower fingers 188 and 208 thus define a right side finger pair.

The fingers 182, 188, 202 and 208 are more than twice as wide as the individual fingers of the repositioner 34, and in effect are evolved from the embodiment of FIGS. 2-8 by the addition of connecting webs 214, 216, 218 and 220. Openings 222, 224, 226 and 228 defined as a result are non-functional, and ornamental in nature.

A left side gap 236 is defined between the distal ends 186 and 206 of the left side finger pair 182, 202. A right side gap 238 is defined between the distal ends 192 and 212 of the right side finger pair 188, 208.

The left side upper finger 182 and the left side lower finger 202, in cooperation with the central portion 164, together define a single generally vertically extending left side slot 240, accessed via the left side gap 236. Correspondingly, the right side upper finger 188 and the right side lower finger 208, in cooperation with the central portion 164, together define a single generally vertically extending right side slot 242, accessed via the right side gap 238.

For installation and use, the user sits in the vehicle seat 22, with the lap belt 26 and shoulder strap 28 in the correct position. The fingers 182, 188, 202 and 208 are flexed as needed to position the shoulder strap 28 between the finger pairs 182, 202 and 188, 208 and the central portion 164, passing through the left and right side slots 240 and 242. Insertion of the shoulder strap 28 is made possible on the left side by the gap 236 and, on the right side, by the gap 238.

Then, the same fingers 182, 188, 202 and 208 are again flexed as needed, and the lap belt 26 is positioned so as to pass through the same slots 240 and 242. Insertion of the lap belt 26 is likewise made possible by the left and right side gaps 236 and 238.

However, it is not necessary for the lap belt 26 to fully engage the left and right side slots 236 and 238. Thus, it is sufficient for the lap belt 26, or at least the lower edge thereof, to engage only the lower fingers 202 and 208. Engagement with the upper fingers 182 and 188 is not required. In any event, in the final installed configuration, the lap belt 26 and shoulder strap 28 cross over portions of the front surfaces of the side wings 170 and 172, and cross over portions of the rear surface of the central portion 164.

As in the case of the repositioner 34, the repositioner 160 is then slid to the left or right, as required, to allow the shoulder strap 28 to ride in the most comfortable position midway between the neck 40 and shoulder, in the same manner as is illustrated in FIG. 1. The grip provided by the finger pairs 182, 202 and 188, 208, and the central portion 164, allows the repositioner 160 to be held in place, while still allowing the user to move the repositioner 160 left or right along the lap belt 26 to provide a comfortable fit of the diagonally-extending shoulder strap 28 for the user. The grip is aided by a bead 244 along the edges of the slots 240 and 242.

The bead 244 actually extends continuously along all exposed edges of the body 162, thus avoiding sharp edges. In addition, the edges of the ornamental openings 222, 224, 226 and 228 have individual continuous beads 246, 248, 250 and 252, respectively, along their edges.

The repositioner 160 of FIG. 9 functions generally in the same manner as the repositioner 34 of FIGS. 2-8. Having the lap belt 26 and the diagonally-extending shoulder strap 28 pass through the same pair of slots 240 (on the left side) and 242 (on the right side) is similar in result. The finger pairs 182, 202 and 188, 208 flex in the event of an accident in order to allow the shoulder strap 28 to separate from the lap belt 26 and move to an optimum position of the diagonal shoulder strap 28 in order to protect the user in a manner consistent with the designed function of the vehicle seat belt assembly 24. In the alternative attachment connection, wherein the lap belt 26 is engaged only by the lower fingers 202 and 208, the same result is achieved. In either event, the repositioner 160 remains attached to the diagonally-extending shoulder strap 28, and so does not become a projectile in the event of an accident.

Likewise, to prevent distortion during use, the central portion 164 is relatively rigid compared to the fingers 182, 188, 202 and 206. The profile of the central portion 164 (which is substantially identical to the profile of the central portion 52 of the repositioner 34 embodiment, as perhaps best seen in the cross-sectional view of FIG. 5), aids in maintaining rigidity.

It may be noted that the repositioner 34 of FIGS. 2-8 is capable of being installed in the same manner as the repositioner 160 of FIG. 9, by ignoring the relatively outer left and right side slots 148 and 150, and employing only the relatively inner left and right side slots 108 and 110 in the same manner as the single left and right side slots 240 and 242 of the repositioner 160 embodiment of FIG. 9.

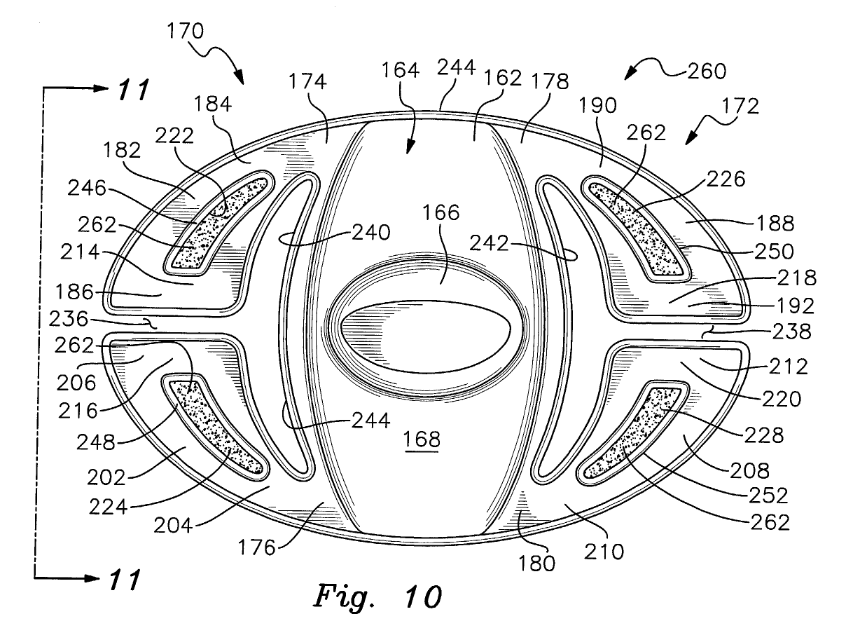

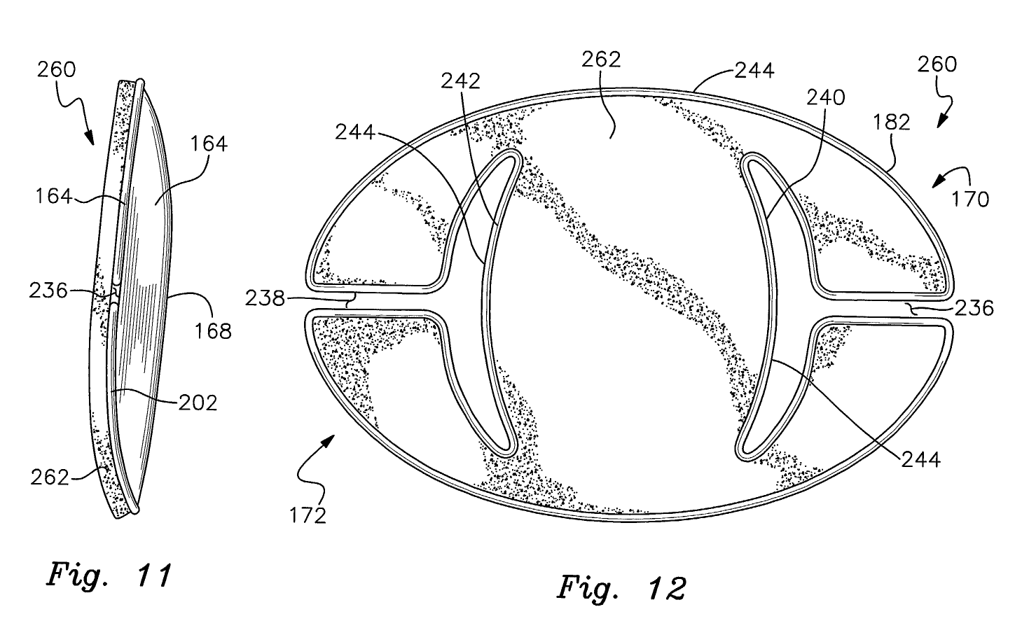

Referring finally to FIGS. 10-12, depicted is a third repositioner 260 embodiment, which differs from the repositioner 160 of FIG. 9 in that a foam backing 262 is included, for added user comfort. As is best seen in the rear elevational view of FIG. 12, the foam backing 262 is cut out to conform to the left and right side slots 240 and 242, as well as the left and right side gaps 236 and 238 that provide access.

In all other respects, the repositioner 260 of FIGS. 10-12 is substantially identical to the repositioner 160 of FIG. 9, and identical reference numerals are accordingly employed as a matter of convenience.

As seen in the rear elevational view of FIG. 12, the foam backing 262 is cut so as to be positioned just inside the bead 244 along the outer edge of the body 162, and along the edges of the left and right side gaps 236 and 238 and the left and right side slots 240 and 242. However, in the illustrated embodiment, the foam backing 262 extends entirely across the ornamental openings 222, 224, 226 and 228. The foam backing 262 is thus partially visible in the front elevational view of FIG. 10.

The repositioner 260 of FIGS. 10-12 is installed and functions in the same manner as the repositioner 160 of FIG. 9. Accordingly, the descriptions of that installation and operation are not repeated.

While specific embodiments of the invention have been illustrated and described herein, it is realized that numerous modifications and changes will occur to those skilled in the art. It is therefore to be understood that the appended claims are intended to cover all such modifications and changes that fall within the true spirit and scope of the invention.

What is claimed is:

1. A shoulder strap repositioner for use in combination with a vehicle seat belt assembly having a lap belt and a diagonally-extending shoulder strap attached to one end of a buckle device, said repositioner comprising a body positionable against the torso of a seated person, said body including:
a central portion having a rear surface that faces the torso during use, and an opposed front surface;
left and right side wings each having a rear surface that faces the torso during use, and an opposed front surface;
each of said side wings including upper and lower base portions attached to said central portion, an upper finger extending from an upper finger proximal end attached to said upper base portion downwardly to an upper finger distal end, a lower finger extending from a lower finger proximal end attached to said lower base portion upwardly to a lower finger distal end, a gap being defined between said upper and lower finger distal ends, and said upper and lower fingers in cooperation with said central portion together defining generally vertically extending left and right side slots accessed via said gaps;
said slots and gaps being configured such that, for use, the lap belt and shoulder strap are inserted through said gaps, and such that, during use, the shoulder strap passes through said slots and the lap belt at least engages said lower fingers, with the lap belt and shoulder strap crossing over portions of said front surfaces of said side wings and crossing over portions of said rear surface of said central portion.

2. The shoulder strap repositioner of claim 1, wherein said fingers are flexible.

3. The shoulder strap repositioner of claim 2, wherein said central portion is relatively rigid compared to said fingers.

4. The shoulder strap repositioner of claim 1, which is configured so as to detach from the lap belt and remain attached to the shoulder strap in the event of a collision.

5. The shoulder strap respositioner of claim 1, wherein said body is curved to accommodate the pelvic contour of the seated person.

6. A shoulder strap repositioner for use in combination with a vehicle seat belt assembly having a lap belt and a diagonally-extending shoulder strap attached to one end of a buckle device, said repositioner comprising a body positionable against the torso of a seated person, said body including:
a central portion having a rear surface that faces the torso during use, and an opposed front surface;
left and right side wings each having a rear surface that faces the torso during use, and an opposed front surface;
each of said side wings including upper and lower base portions attached to said central portion, an upper relatively inner finger extending from an upper relatively inner finger proximal end attached to said upper base portion downwardly to an upper relatively inner finger distal end, a lower relatively inner finger extending from a lower relatively inner finger proximal end attached to said lower base portion upwardly to a lower relatively inner finger distal end, a relatively inner gap being defined between said upper and lower relatively inner finger distal ends, said upper and lower relatively inner fingers in cooperation with said central portion together defining generally vertically extending relatively inner left and right side slots accessed via said relatively inner gaps, an upper relatively outer finger extending from an upper relatively outer finger proximal end attached to said upper base portion downwardly to an upper relatively outer finger distal end, a lower relatively outer finger extending from a lower relatively outer finger proximal end attached to said lower base portion upwardly to a lower relatively outer finger distal end, a relatively outer gap being defined between said upper and lower relatively outer finger distal ends and said upper and lower relatively outer fingers in cooperation with said upper and lower relatively inner fingers together defining generally vertically extending relatively outer left and right side slots accessed via said relatively outer gaps;
said slots and gaps being configured such that, for use, the shoulder strap is inserted through said relatively inner gaps and the lap belt is inserted through said relatively outer gaps and such that, during use, the shoulder belt passes through said relatively inner slots and the lap belt at least engages said lower relatively outer fingers, with the lap belt and shoulder strap crossing over portions of said front surfaces of said side wings and crossing over portions of said rear surface of said central portion.

7. The shoulder strap repositioner of claim 6, wherein said fingers are flexible.

8. The shoulder strap repositioner of claim 7, wherein said central portion os relatively rigid compared to said fingers.

9. The shoulder strap repositioner of claim 6, which is configured so as to detach from the lap belt and remain attached to the shoulder strap in the event of a collision.

10. The shoulder strap repositioner of claim 6, wherein said body is curved to accommodate the pelvic contour of the seated person.
